(19) United States
(12) Patent Application Publication
(10) Pub. No.: US 2002/0098060 A1
(43) Pub. Date: Jul. 25, 2002

(54) Multi-function push-pin

(75) Inventors: Scott Robert Kochlefl, Urbana, IL (US); Michael James Vostal, Champaign, IL (US); Laura Kathleen Naughton, Champaign, IL (US); Matthew Stewart Wertz, Champaign, IL (US); Teresa Paz Nalus Barin, Champaign, IL (US)

Correspondence Address: Scott Kochlefl, 657 W. Oakdale Ave., #3B, Chicago, IL, 60657-5374, US

(73) Assignee: THE BOARD OF TRUSTEES OF THE UNIVERSITY OF ILLINOIS

(21) Appl. No.: 09/767,201

(22) Filed: Jan. 22, 2001

(51) Int. Cl. F16B 37/14; F16B 15/00

(52) U.S. Cl. 411/429

(57) ABSTRACT

A push-pin including a slot dividing a body into multiple portions and having at least two pins extending from separate ones of the multiple portions. The preferred push-pin includes a pushing surface on one end of the body. A pulling surface is generally defined around the body. The slot divides the body into at least two portions. Material of the body is selected to allow some movement of the divided portions of the body without permanent deformation thereof. This allows the portions return to their relaxed position when an applied force is removed. An opening of the slot has rounded surfaces defined on the body portions. The remaining area defined by the slot 16 may be wider than the opening, allowing an object to be held in the slot after passing the opening. The dimensions of the slot are selected to accommodate different sized objects as a matter of design variation within the scope of the invention. Preferably, the body 12 is made of anodized Aluminum (Al).

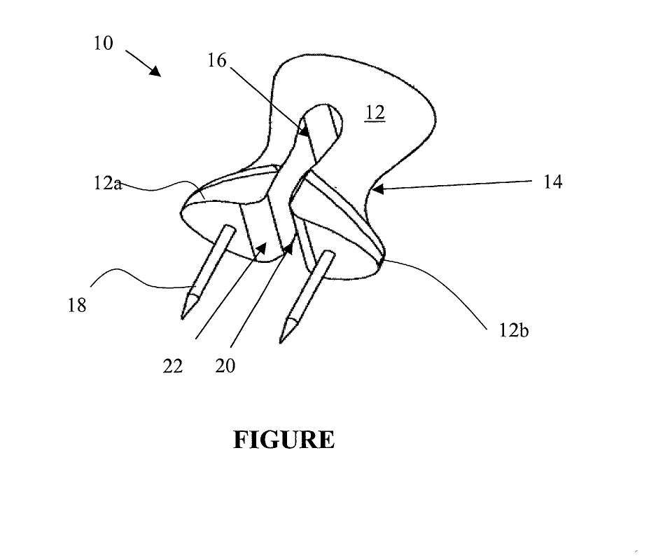

### FIELD OF THE INVENTION

The field of the invention is push-pins. Push-pins are readily inserted and removable by a human hand unaided by tools.

### BACKGROUND OF THE INVENTION

Push-pins are directed primarily toward use on bulletin boards. A traditionally design includes a body and a pin extending from the body. The body includes surfaces which facilitate insertion and removal, i.e., pushing and pulling, by a human hand without the aid of a tool. The traditional design is well-suited for its primary purpose of hanging paper from bulletin boards. It is less well-suited for other purposes for which people often use it, such as hanging wires and other objects from walls. The obvious reason people choose a push-pin for such other functions is that lack of a required application tool makes it exceedingly convenient. Despite the potential for such alternate uses, the traditional design remains entrenched in its traditional paper piercing functionality. Thus, there is a need for an improved push-pin.

### SUMMARY OF THE INVENTION

This need is met by the present multi-function push-pin. A push-pin of the invention includes a body having surfaces for pushing and grabbing by a human hand. An end of the body opposite the pushing surface includes a slot extending into and dividing the body into multiple portions. At least two pins extend from separate ones of the multiple portions. The slot allows the body to accommodate and hold a small object such as a wire or a hook.

Preferably, the slot has rounded smooth surfaces and has an opening that is narrower than its remaining volume. The portions of the body at the opening may be moved slightly away from each other to accept an object. The object then becomes locked into place when the at least two pins are inserted into a surface. Because the object is accommodated by the slot, the at least two pins may be fully inserted.

### BRIEF DESCRIPTION OF THE DRAWING

Other features, objects, and advantages of the invention will be apparent by reference to the FIGURE, which is a perspective view or a preferred embodiment push-pin of the invention.

### DETAILED DESCRIPTION OF THE PREFERRED EMBODIMENT

Referring now to the FIGURE, a preferred embodiment push-pin 10 of the invention. The push-pin 10 includes a body 12 having a pushing surface 14 on one end. A pulling surface 14 is generally defined around the body 12. A slot 16 divides the body 12 into two portions 12a, 12b. Material of the body is selected to allow some movement of the divided portions of the body 12 without permanent deformation. In other words, the portions may be moved closer together or further apart and will return to their relaxed position when force is removed. Two pins 18 extend from these portions. An opening 20 of the slot 16 has rounded surfaces 22 defined on the portions 12a, 12b to facilitate accepting an object such as a wire or a hook. The remaining area defined by the slot 16 may be wider than the opening, allowing an object to be held in the slot after passing the opening 20 and causing the two portions 12a, 12b to separate slightly. The dimensions of the slot are selected to accommodate different sized objects as a matter of design variation within the scope of the invention. Once an object is accommodated in the slot 16, the pins 18 may be fully inserted into a surface up to the point where they meet the two portions of the body 12.

The push-pin 10 is also an improvement for a traditional push-pin use. If the push-pin 10 is used to secure paper, for example, the at least two prong arrangement serves to inhibit rotation of the paper.

Preferably, the body 12 is made of Aluminum (Al). Al has a high strength-to-weight ratio and may be made resistant to oxidation by formation of an initial oxide film on the surface of the aluminum. Anodization to form an oxide film also allows a wide range of decorative coloring options.

The preferred method for forming an aluminum bodied push-pin of the invention is metal injection molding. In metal injection molding, a small sized metallic powder is mixed with a wax-polymer binder that allows shaping in a thermoplastic injection molding machine. After shaping, the wax-polymer binder is removed, typically by heating, and then the structure is sintered in a manner similar to traditional powder metallurgy or ceramics firings.

While a specific embodiment of the present invention has been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A push-pin comprising:
a body, the body having a pushing surface on one end thereof to facilitate pushing by a person and a pulling surface disposed around the body to facilitate gripping by a person;
a slot extending into the body from an opposite end of the body and dividing the body into at least two portions, the slot defining a space to accommodate an object; and
at least two pins extending from at least two separate ones of said at least two portions.

2. The push-pin according to claim 1, wherein said at least two portions are rounded at said opposite end to provide said slot with a rounded opening.

3. The push-pin according to claim 2, wherein said slot is narrower at said opening than at another area of said slot.

4. The push-pin according to claim 1, wherein said at least two portions of said body may be moved slightly away from each other to accept an object and will return to a relaxed position in the absence of applied force.

5. The push-pin according to claim 1, wherein said body is formed of anodized aluminum.
